(19) United States
(12) Patent Application Publication
(10) Pub. No.: US 2014/0156509 A1
(43) Pub. Date: Jun. 5, 2014

(54) Collateral Mechanisms

(71) Applicant: RISCONSULTING GROUP LLC, THE, Boston, MA (US)

(72) Inventor: Derrell J. Hendrix, Brookline, MA (US)

(73) Assignee: RISConsulting Group LLC, The, Boston, MA (US)

(21) Appl. No.: 13/693,131

(22) Filed: Dec. 4, 2012

(51) Int. Cl. G06Q 20/38

(52) U.S. Cl. CPC G06Q 20/38
USPC 705/39

(57) ABSTRACT

Techniques for providing collateral and satisfying collateral requirements are disclosed. The techniques involve participation rights to allow a second party having commercial contracts with a first party to draw against assets of a legal trust whose assets are funded by investors, determining terms for issuance of the obligations, including a guarantee by the first party to redeem assets in the legal trust that are drawn by the second party and recording contracts formed with two or more independent contract providers that are jointly and severally liable for a negative difference between the value of assets the first party contributes to the legal trust and the value of the assets actually drawn by the second party.

### BACKGROUND

This disclosure relates to mechanisms for providing collateral and satisfying collateral requirements under various governmental regulations and business requirements.

Financial institutions and related entities are typically regulated by governmental agencies to ensure that, among other things, the institutions and entities have sufficient capital, as well as sufficient collateral resources to support their investment activities. For example, certain types of United States (U.S.) insurance companies and reinsurance companies are required by the U.S. state insurance regulations to post a required amount of qualifying collateral in order to underwrite policies to their clients. Recently the United States has passed Public Law 111-203 Jul. 21, 2010 short title “Dodd-Frank Wall Street Reform and Consumer Protection Act.” In addition, a global standard on banking commonly known as the “Basel Accords” and in particular “Basel III” introduced among other things new regulatory requirements on banking liquidity and leverage. Large buyers of insurance and reinsurance policies may require that their insurance and reinsurance providers be credit-enhanced to alleviate risk-based capital charges, and/or individual insurance company and/or reinsurance company credit concentrations. Examples of collateral mechanisms for providing collateral and satisfying collateral requirements are also disclosed in my Issued U.S. Pat. No. 7,769,655 the contents of which are incorporated herein by reference in their entirety.

### SUMMARY

According to an aspect of the invention, a computer-implemented method includes recording receipt of a first request for obligations that grant to a first party a first participation right to allow a second party having commercial contracts with the first party to draw against assets of a legal trust, at least some of the assets in the legal trust being funded by investors, determining terms for issuance of the obligations, the terms including a guarantee by the first party to redeem assets in the legal trust that are drawn by the second party, recording, by the one or more computers, a first set of contracts formed with two or more independent contract providers unrelated to the first and second parties, the contract providers being jointly and severally liable for a negative difference between the value of assets the first party contributes to the legal trust and the value of the assets actually drawn by the second party, and recording, by the one or more computers, a transfer of the requested obligations to a collateral account that benefits the second party.

According to an additional aspect of the invention, a computer program product tangibly embodied on a computer readable storage device includes instructions to record receipt of a first request for obligations that grant to a first party a first participation right to allow a second party having commercial contracts with the first party to draw against assets of a legal trust, at least some of the assets in the legal trust being funded by investors, receive terms for issuance of the obligations, the terms including a guarantee by the first party to redeem assets in the legal trust that are drawn by the second party, record a first set of contracts formed with two or more independent contract providers unrelated to the first and second parties, the contract providers being jointly and severally liable for a negative difference between the value of assets the first party contributes to the legal trust and the value of the assets actually drawn by the second party, and record a transfer of the requested obligations to a collateral account that benefits the second party.

According to an additional aspect of the invention, a system includes one or more computer system, each system including a processor and memory coupled to the processor, and the computer system is configured to record receipt of a first request for obligations that grant to a first party a first participation right to allow a second party having commercial contracts with the first party to draw against assets of a legal trust, at least some of the assets in the legal trust being funded by investors, receive terms for issuance of the obligations, the terms including a guarantee by the first party to redeem assets in the legal trust that are drawn by the second party, record a first set of contracts formed with two or more independent contract providers unrelated to the first and second parties, the contract providers being jointly and severally liable for a negative difference between the value of assets the first party contributes to the legal trust and the value of the assets actually drawn by the second party, and record a transfer of the requested obligations to a collateral account that benefits the second party.

Implementations may include one or more of the following features.

The first set of contracts comprises wrap contracts. The risks associated with issuing the requested obligations are determined. The terms for issuance of the obligations are determined based on the determined risks. The contract providers comprise financial institutions including banks or insurance companies or reinsurance companies. The first set of contracts is structured as unconditional payment guarantees or total return swaps or other guaranty contracts. The first set of contracts is used exclusively for the obligations transferred based on the first request.

Implementations can further involve recording by the one or more computers receipt of other requests for obligations that grant to the first party participation rights to allow other parties having commercial contracts with the first party to draw against the assets of the legal trust and recording, by the one or more computers, additional sets of contracts formed with the two or more independent contract providers and/or other independent contract providers, different sets of contracts including the first set of contracts being independent of each other, and each set of contracts being used for a respective request for obligations.

Other implementations can further involve recording by the one or more computers receipt a second request for obligations that grant to a third party a second participation right to allow a fourth party having commercial contracts with the third party to draw against the assets of the legal trust, determining terms for issuance of the obligations, the terms including a guarantee by the third party to redeem assets in the legal trust that are drawn by the fourth party, recording, by the one or more computers, a second set of contracts formed with the two or more independent contract providers and/or other independent contract providers that are jointly and severally liable for a negative difference between the value of the assets the third party contributes to the legal trust and the value of assets actually drawn by the fourth party.

The assets in the legal trust also comprise eligible assets obtained from the first party for use in redeeming the assets drawn by the second party. The eligible assets are obtained before the transfer of the requested obligations

Qualifying collateral may include, for example, cash or securities listed by the Securities Valuation Office of the National Association of Insurance Commissioners (NAIC). Qualifying collateral can also be eligible assets (e.g., the qualifying assets) that are placed in a qualifying trust, Letters of Credit (LOCs) that are either issued or confirmed by banks domiciled in the U.S. or by U.S. branches of foreign banks that are approved by the NAIC in an acceptable form (e.g., clean, irrevocable, unconditional and etc.), or any other forms of security acceptable to the various state insurance commissioners.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an arrangement for managing transactions among entity computer systems for providing and satisfying collateral requirements.

FIG. 2 is a block diagram of an alternative arrangement for managing transactions among entity computer systems for providing and satisfying collateral requirements.

FIG. 3 is a flow diagram.

FIG. 4 is a block diagram of other aspects of transactions for providing and satisfying collateral requirements.

FIG. 5 is a block diagram of a capital structure.

FIG. 6 is a block diagram of platform for multiple clients.

FIG. 7 is a block diagram of an exemplary computer system.

### DETAILED DESCRIPTION

The demand for entities to obtain collateral to provide statutory surplus relief and credit enhancement is growing rapidly. That is, demand in financial markets for collateral has increased because the needs for collateral have spread to additional counterparties involved in financial transactions. For example, the Dodd-Frank legislation in the United States and the global regulatory standard Basel III are expected to significantly expand the market requirements for posting collateral. Regulatory requirements to raise capital that business entities are required to satisfy include collateral requirements for underwriting insurance or reinsurance policies. Such insurance companies require the collateral either for credit requirements and/or regulatory requirements. Examples of business needs include credit enhancement for potential payment obligations. Ideally, a platform 10 as discussed below is structured to satisfy applicable regulatory requirements such as Basel III and Dodd-Frank.

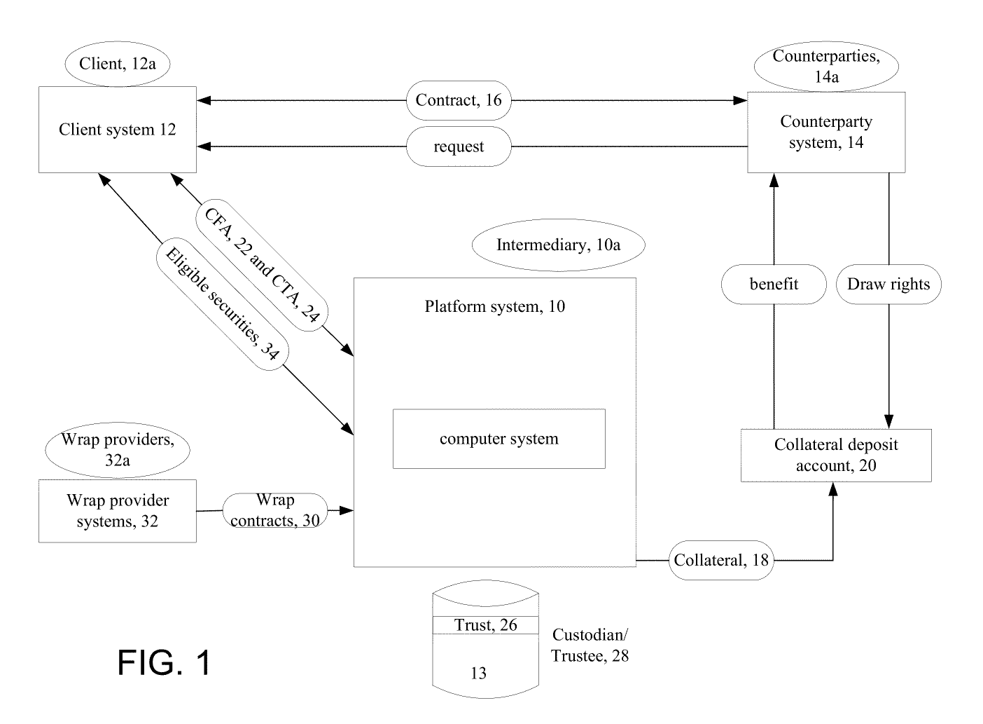

Referring to FIG. 1, platform 10 to provide collateral mechanisms to business entities that need collateral (to satisfy regulatory requirements and/or non-regulatory business needs) for trading is shown. The platform 10 includes a computer system 11 that communicates with other systems including a client system 12 associated with a client 12a, a counterparty system 14 associated with a counterparty 14a and wrap provider systems 32 associated with wrap providers 32a. In some cases, the wrap provider is a third party, whereas in other cases, under Dodd-Frank the wrap provider is the client. In either case there is a wrap provider and a wrap, but form of the wrap may differ. The platform 10 is operated by an intermediary 10a that receives a fee in exchange for arranging the provision of collateral. In general, the platform 10, client system 12, counterparty system 14 and wrap provider systems 32 are or involve corresponding computer systems and in some instances may involve manual operations.

The platform 10 manages a trust that is shown in FIG. 1 as a trust 26. The trust is managed via a custodian/trustee 28. In FIG. 1 and in the remaining figures as appropriate, the trust or (trusts) are represented as a storage element in a database 13 (or the like). This representation can be considered as part of the platform 10, in that the intermediary may possess a computer representation of and/or acknowledgement of the existence of the trust in order to facilitate transactions involving the trust through the custodian/trustee 28.

The trust 26 holds assets to support issuance of qualifying collateral. To trade with, e.g., to form a contract 16 with, a business counterparty 14a, a business entity (client 12a) obtains collateral through the platform 10 by forming a Collateral Facility Agreement (CFA) 22 and one or more Collateral Transaction Agreements (CTAs) 24. For purpose of the discussion, the business entity 12a and the client 12a of the platform 10 are used interchangeably. In particular, a counterparty system 14 sends a request 36 specifying the collateral needed for the trading to the platform 10 that issues collateral 18 at an amount, as requested or lower than requested, under the CFA 22 and the CTA 24 with the business entity 12a. In an analogous manner, as a commitment agreement from a bank, a CFA includes the total amount of the commitment, the time during which the CFA can be drawn against, and the maximum length of a transaction. The CFA also provide such representations, warranties and covenants that apply to all CTAs. The issued collateral 18 is deposited into an account 20 that is provided for the transaction necessitating the collateral request to benefit the business counterparty 14a. The collateral 18 can be, e.g., in the form of a collateral note referencing a portion of assets set aside in the trust 26 for the note, or in the form of assets moved from the trust 26. The account 20 can be in the form of a trust that complies with regulatory requirements or non-regulatory business requirements. Once issued and deposited, the collateral 18 can be drawn unconditionally by a holder of the collateral or a beneficiary of the account 20.

In such an arrangement, the intermediary 10a that operates the platform 10 and the trust 26 may be exposed to risks of losing assets without full recovery when the counterparty 14a draws the collateral 18. The platform 10 implements several mechanisms to reduce its risks in losing the drawn assets without recovery. One such mechanism is a guarantee by the business entity 12a, where the business entity guarantees to pay the drawn amount back to the trust 26, e.g., under the CFA 22 and CTAs 24, in exchange for the issuance and deposit of the requested collateral 18.

In addition, the platform 10 obtains available assets, e.g., eligible securities 34, of the business entity (client) 12a (details discussed below) and holds such assets in the trust 26. These assets can be provided to the counterparty 14a first when the counterparty 14a draws the collateral 18. Alternatively, in some implementations, the platform 10 takes these available assets when the counterparty 14a draws assets from the trust and the business entity fails to pay the drawn amount.

In another mechanism, the platform 10 receives wrap contracts 30 from one or more wrap contract providers 32a to effectively provide insurance to the assets in the trust 26. As used herein, a wrap contract is a contract under which a party guarantees the obligations of another party. A wrap contract can take the form of a “Letter of Credit,” “Financial Guaranty Insurance” policy or a derivative instrument such as a “Total Return Swap” or “Credit Default Swap.” The wrap contracts are entered into between the intermediary and the wrap contract providers 32a. The wrap contract providers 32a can be jointly and severally liable to make the trust 26 whole upon each collateral withdrawal. For example, when the business entity 12a fails to perform under the agreements and defaults on paying or reimbursing the drawn amount or when the business entity 12a fails to pay the drawn amount in full, the wrap contractors 32a pay the difference and make up any shortfall in the assets in the trust 26. A set of wrap contracts are formed for each request or issuance of collateral 18. Thus, when the entity draws on the collateral note and is made whole, a reimbursement obligation comes into existence that accrues to the trust, but which is taken on behalf of the payer. In other words, the trust assigns its right to any collection from the client to the payer that actual made the payment.

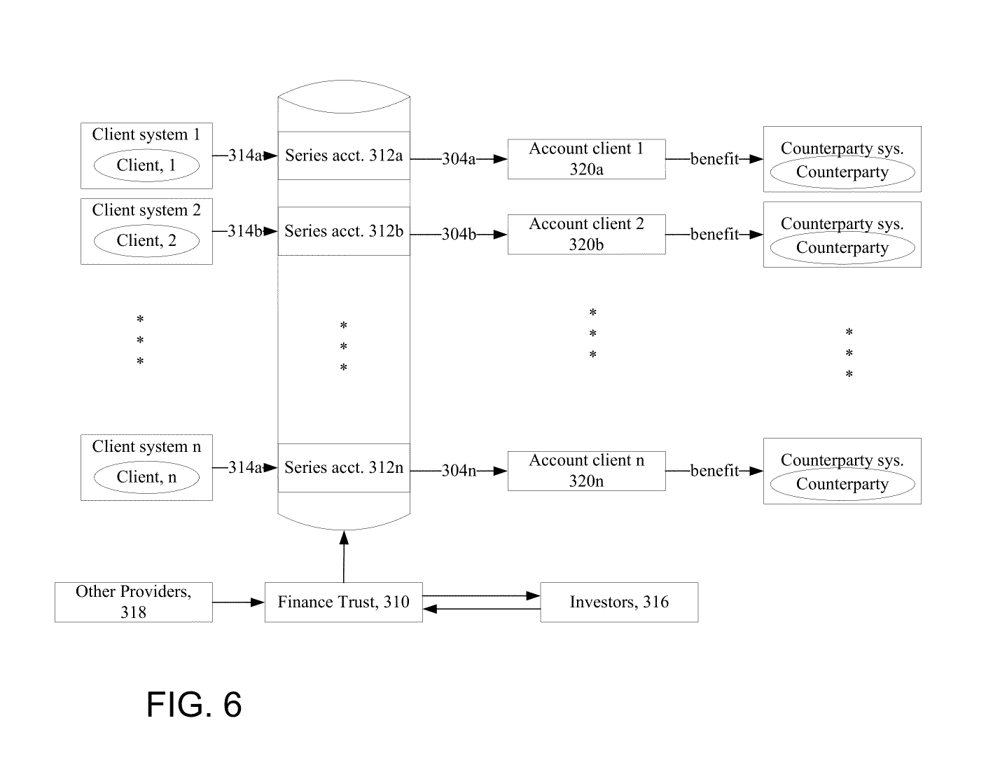

The business entity 12a and the business counterparties 14a can be any financial entities, such as insurance companies, reinsurance companies, banks, and others. The contract 16 can be insurance contracts, reinsurance contracts, derivative contracts, and others. Although only one client 12a is shown in the figure, the platform 10 serves, e.g., simultaneously multiple clients (see FIG. 6).

The client 12a pays fees to the intermediary through the platform 10 for the collateral note issuance and for the deposits of collateral, based on the face amount of the collateral notes at a market rate for similar collateral arrangements (such as bank letters of credit at the margin). For example, comparable rates may range between 45 and 100 basis points per annum, depending on the client claims-paying ratings and the combined (i.e., default/subject business) risk analysis.

The guarantee from the client to make a payment or to reimburse the trust 26 may be specified in the CTA 24. The guaranty from the client is generally to make payment on the draw. Only if the client defaults on that payment obligation, and another party makes the payment, will there be a reimbursement obligation. In some implementations, the available assets from the client 12a are in the form of eligible securities owned by the client. The guaranty in the insurance context is typically an unfunded obligation from a parent or other highly rated member of the same affiliated group as the client. In the Dodd-Frank, situation the client itself may furnish assets so that the wrap provider assumes the risk that the client assets are insufficient in value to fund a draw on the collateral note.

The platform 10, e.g., through the trustee 28, obtains an agreed or predetermined amount of eligible securities based on the requested collateral 18. In some implementations, before entering into the CTA 24, the trustee 28 obtains the eligible securities from custody accounts of the client 12a through an automatic process through the client system 12 and deposits the obtained eligible securities in to a series account (not shown) in the client's name in the trust 26. The custodian enters into a custodian agreement with the client and under that agreement the custodian is authorized to take funds from their accounts and the funds in the Trust Account. Typically, that would not require authorization each time the custodian need securities. The series account and the assets therein are used only for the particular client 12a and no other clients of the platform.

Other series accounts are established for other clients (see, FIG. 6). The eligible securities are subject to a first priority lien held by the holder of collateral 18 so that the assets in the reference account 48 are drawn first before the other assets in the trust 26. The first priority lien on the deposited eligible securities can only be released if alternative collateral arrangements are entered into and the collateral 18 is returned for cancellation. Alternatively, the eligible securities are deposits held by the platform 10. When the client 12a defaults, the platform 10 uses the assets to pay and then causes a demand for payment to be sent to the client. Such eligible securities may be used by the platform 10 to reimburse the trust 26 before the wrap contracts 30 are enforced. When the collateral 18 is exhausted, e.g., used or returned to the trust 26, the unused eligible securities in the client's series account are returned to the client, e.g., through transactions with the client system 12.

Under certain CTAs 24, the client 12a is obliged to margin the eligible securities daily based on securities valuations. If the market value of the deposited eligible securities falls below the required amount as a result of market price movements, additional eligible securities will be obtained from the client via the client system 12 by an automatic process such as sending a message to the computer 12 to cause a transfer of additional eligible securities from the client 12a.

The eligible securities can have various forms. For example, in the U.S., they can be fixed income securities that qualify for NY State Regulation 114 (a so called “114 Trust”) and U.S. equities that qualify as admitted assets for NY-domiciled insurance companies. In Europe, they can be fixed income securities denominated in U.S. dollars, Euros and/or British pound sterling (GBP) and rated A− or better, and equities traded on a major European exchange, e.g., Germany, the United Kingdom, or France. Other considerations such as ratings and trading characteristics can be used of course to designate securities as “eligible securities.” In other countries/regions similar, corresponding considerations could be used.

The wrap contracts 30 fund at least any negative difference between the actual value of the eligible securities in the client's series account and the required value of the eligible securities (including any haircuts) for the collateral 18 to be issued to the client 12a.

The wrap providers 32a may be any financial institution including a bank, an insurance/reinsurance company and so forth that is rated A− or better by one or more nationally recognized statistical ratings organizations (NRSRO) such as Standard and Poor's, Moody's and Fitch issued from a branch in the U.S. (for U.S. collateral requirements) or in Germany, the United Kingdom, France and other European countries (for European collateral requirements) or that satisfies agreed minimum capital requirements. In other countries/regions, similar considerations would apply. The wraps contracts 30 can be structured as unconditional payment guarantees, total return swaps, or any other form of unconditional payment obligation deemed acceptable, e.g., by the appropriate governmental regulatory agencies such as the European Central Bank (ECB), the Federal Reserve Bank, the Office of the Comptroller of the Currency (OCC) and the National Associations of Insurance Commissions (NAIC) for European and US based collateral transactions. When multiple wrap providers 32a are used, the wrap providers have joint and several liability on their obligations under the wrap contracts 30.

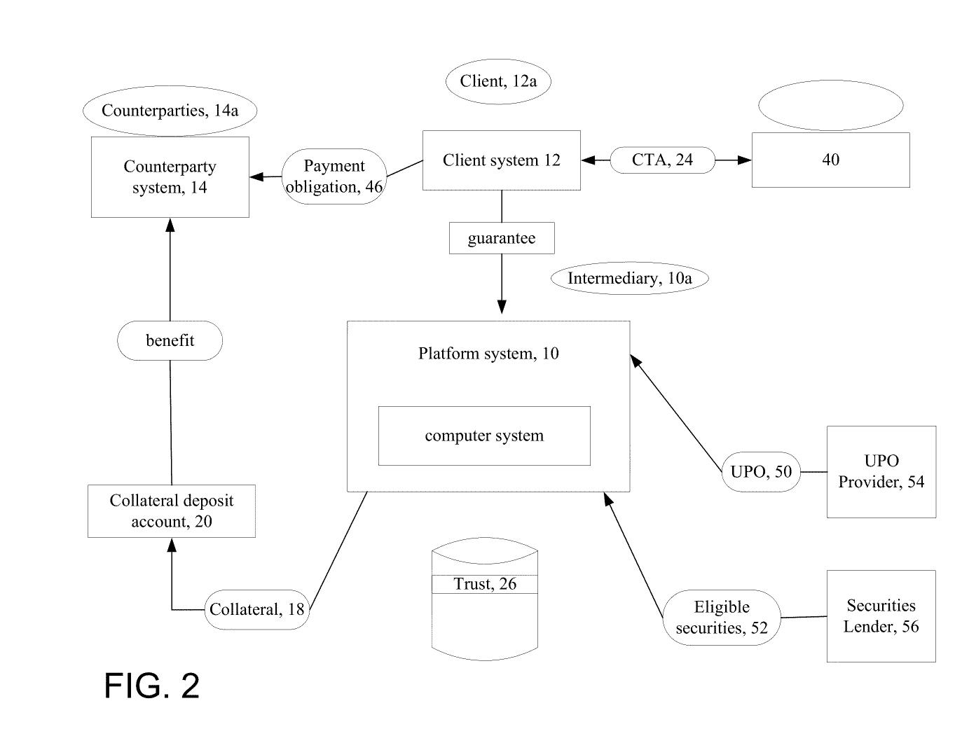

Referring to FIG. 2, when a client 12a enters into a CTA 24 with the platform 10, the client 12a has CTA rights 42 against the trust 26, which requires the platform 10 to deposit the collateral 18 into the account 20 for a beneficiary 14a (or business counterparty of the client 12a). In exchange to the CTA rights 42, the CTA 24 also requires the client 12a to provide a guarantee to the platform 10 that when the deposited collateral 18 is drawn from the trust 26 by the beneficiary 14a, the client 12a pays the platform 10 the drawn amount in full. A special purpose entity 40 is organized either onshore or offshore to participate in specific transactions.

In the example shown in the FIG. 2, the collateral 18 is a collateral note and no tangible assets are deposited in the account 20. Corresponding to the issued collateral note, a reference account 48 is set in the trust 26 to hold an amount of assets that corresponds to the face value of the collateral note. Assets in the reference account 48 are frozen relative to the other assets in the trust 26 and are only usable for the corresponding collateral note. The reference account 48 is closed when the CTA 24 ends and unused assets in the account 48 are released to join the other assets in the trust 26 for use in other purposes, e.g., other collaterals issuance and deposits under other CTAs formed with the client 12a. In some implementations, the client is required to pay commitment fees on the assets allocated in the reference account 48 before entering in to the CTA 24, e.g., at a rate of 0.1% per annum and payable monthly in advance.

In some implementations, the assets in the reference account 48 drawable by the beneficiary 14a have a rating of A− or better and include at least two types. The first type includes one or more unconditional payment obligations (UPO) 50, e.g., in the form of a letter of credit, credit default swap, or a liquidity obligation issued by one or more UPO providers 54 rated A− or better. The second type includes eligible securities, e.g., marketable fixed-income securities rated A− or better, and/or listed equities, provided by one or more security providers. In some implementations, the UPO providers 54 include the client 12a and the UPO 50 is from the client's bank. The UPO providers 54 can also be independent third parties rated A− or better. The eligible securities 52 can be held in the trust 26 as security backing the UPO's obligations. As explained previously, part of the eligible securities may be obtained from the client 12a and held in the client's series account in the trust 26. These and possibly other assets in the reference account 48 are margined daily to maintain an aggregate market value equal to the face value of the collateral note. In general wrap providers and UPO providers perform similar functions.

Under the CTA 24, the collateral note is an obligation of the trust 26 to pay a holder of the collateral note, i.e., the beneficiary 14a, up to the face amount of the collateral on demand unconditionally. In certain agreements, the issued collateral note is irrevocable and is perpetual in maturity until surrendered or sold by the holder of the collateral note.

Under some CTAs 24, the collateral notes have a one-year maturity and an interest coupon equal to six (6) months LIBOR flat once delivered to a holder or sold to third parties, where LIBOR is the rate banks in London charge each other for overnight loans (London Inter-Bank Offered Rate) and flat means that the rate is neither discounted nor marked up from the base LIBOR rate, but is in fact the rate. While LIBOR is mentioned herein, any generally accepted reference interest rate can be used in substitution for LIBOR. The collateral notes are rated A− or better by at least one nationally recognized statistical rating organization based on the quality of assets held in trust 26 and the reference account 48. The collateral notes are freely marketable if drawn by beneficiaries, such as the counterparty 14a.

In addition to directly drawing assets from the trust 26 based on the collateral note, the beneficiary, e.g., the counterparty 14a, of the account 20 can also hold the collateral note as an investment, sell the collateral note in capital markets, or exchange the collateral note for cash and/or securities of the trust 26 in an amount equal to the collateral note's pro-rata share of the market value of the trust 26 at the time of exchange. A beneficiary may also request the trustee 28 (FIG. 1) to sell or redeem the collateral note on its behalf, and deposit the redeemed assets, e.g., in cash form or securities directly into the beneficiary's account 20. Generally, such transactions with the collateral notes by the beneficiary are referred to as note conversions.

Some types of note conversions, such as withdrawal, would trigger the reimbursement requirement of the client 12a for the full converted amount. If a client fails to re-pay the drawn amount according to the terms specified in the CTA 24, under subrogation terms, the platform may have a security interest in the client's cash flows related to the contract 16, other cash flows or assets of the client 12a that are documented for the collateral issuance/deposition, and/or the assets/securities deposited in the trust 26 prior to the collateral issuance/deposition. In some implementations, the client 12a is allowed to pay the withdrawn amount over a period of time, e.g., one year, with payment of interest over the period. This interest rate may be as high as prime and an additional margin amount.

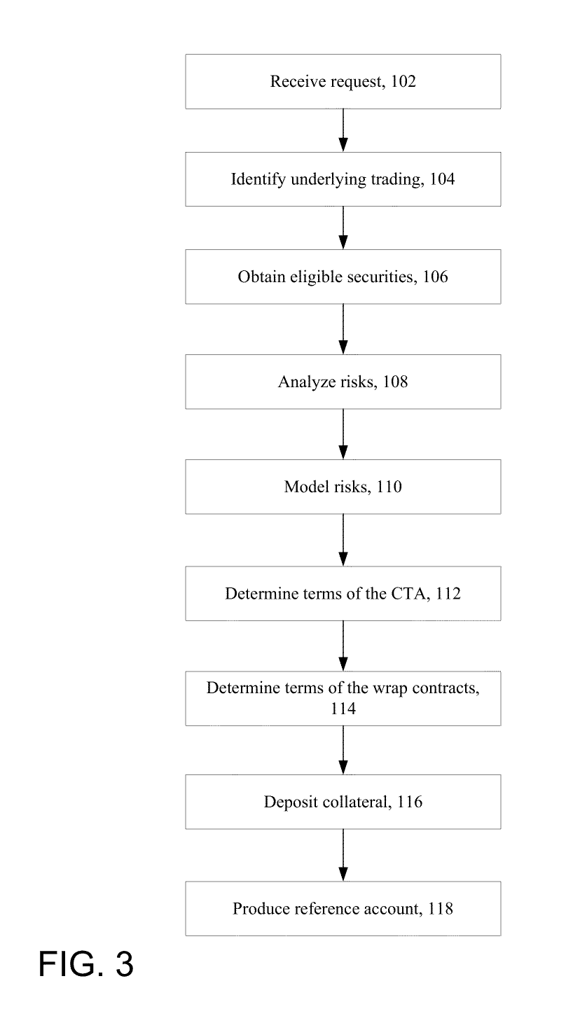

Referring to FIG. 3, a process 100 executed using the platform 10 is shown. The client through client system 12 and intermediary operating the platform 10 enter into a CTA 24. Initially, the counterparty 14a and/or the client 12a assess the amount of collateral needed to be acquired from the platform 10 for the intended trading. The counterparty 14a and/or the client 12a submit the request 36 to the platform 10, e.g., to meet the initial margin requirement. Upon receiving 102 the request, the platform 10 identifies 104 the underlying trading, which may involve derivative contracts, reinsurance treaties, etc. The platform 10 may also identify the parties of the trading, e.g., particularly the party (obligor, typically the client 12a) who will be obliged to pay (e.g., reimburses) the trust 26 when the other party draws assets of the trust 26. Eligible securities 34 are obtained 106 from the client 12a. The platform 10 analyzes 108 the risks associated with the underlying trading, e.g., by modeling 110 the risks. The risks include, for example, a probability of the beneficiary drawing against the assets in the trust 26, a probability of the obligor defaulting on the reimbursement, and others.

Based on the assessed risks, the intermediary operating the platform 10 determines and negotiates 112 terms of the CTA with the client. The terms can include the amount of collateral 18 to be provided, the fees that the client 12a pays to the intermediary through the platform 10, the reimbursement guarantee 44 by the client, the form of payment for the fee and/or the reimbursement guarantee, etc. The intermediary operating the platform 10 also determines and negotiates 114 terms of wrap contracts 30 with one or more wrap providers for the particular collateral 18 to be deposited. After the parties agree upon the terms of the CTA and the terms of the wrap contracts, the platform 10 records a deposit 116 of the collateral 18 into the account 20 for the counterparty 14a. In some implementations, the platform 10 generates the account 20 before making the deposit. The platform 10 also forms 118 the reference account 48 in the trust 26 for the collateral 18 to be deposited or deposited.

The fees to be collected by the intermediary operating the platform 10 for issuance of collateral 18 to the client 12a are in the range of market rates for similar collateral arrangements, such as bank LOCs, for comparably rated clients, taking into account the tenor of the desired collateral. In some implementations, the fees are calculated as a percentage of the face value of the collateral per year, and are payable in advance on a net present value basis. The fees are paid in advance on a net present value basis calculated for collateral issuance/deposition. Sometimes the fees are set at a discount rate and or based on another methodology mutually agreed upon.

The fees to be paid by the intermediary operating the platform 10 to the wrap providers 32a are determined based on the combination of risk based capital charges and desired return on equity. These transactions tend to be one of a kind transactions and finding established market rates for similar transactions would be difficult. However, because the banks are in essence giving a guarantee, one guide that can be used is the cost of a credit default swap on that client that would provide a similar guarantee. While this may be an imperfect measure because the described arrangement in general will carry a much lower risk of default than a general CDS is meant to cover, it is nonetheless one measure by which banks can base fees. The model for use in analyzing risks associated with the underlying trading is in some implementations a stochastic model. In the example of reinsurance businesses, a stochastic model measures the combined risk of, e.g., a reinsurance claim, a client/obligor default and the likelihood and amount of any recovery under other security arrangements. The model will also take into account macro-economic factors such as Gross Domestic Product and Interest Rates. The model is also used to estimate the probability distribution of possible losses to be undertaken by the platform 10 and the trust 26. Information related to the assessed losses and risks for issuing collateral in response to a request can be used to determine the type of assets to be placed in the reference account 48.

The model combines an analysis of collateral depositions with an analysis of the asset portfolio in the trust 26. Each collateral deposit is modeled independently to analyze the combined risk of losses relating to the underlying contracts 16 (e.g., insurance and performance guarantees) and the migration/default risk of the respective client 12a, and net of recoveries. A differentiated risk class of contingent (i.e., insurance-linked) credit risk is assessed to serves as the basis for rating and pricing the collateral deposit. Through such an integrated modeling approach, funding is made available from sophisticated investors seeking greater transparency to support rigorous risk/return assessment.

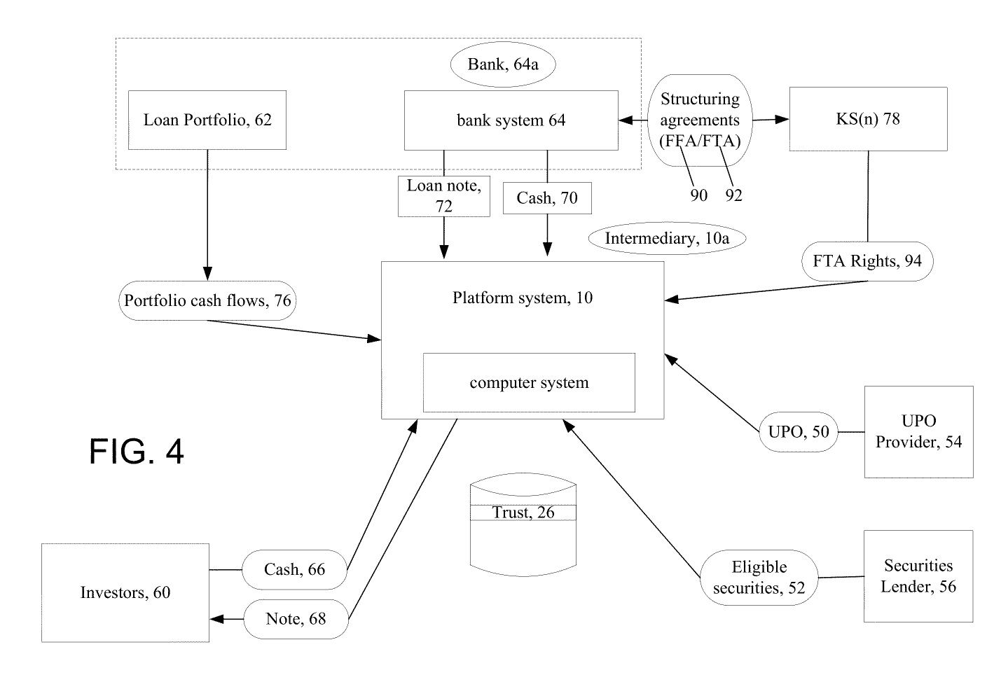

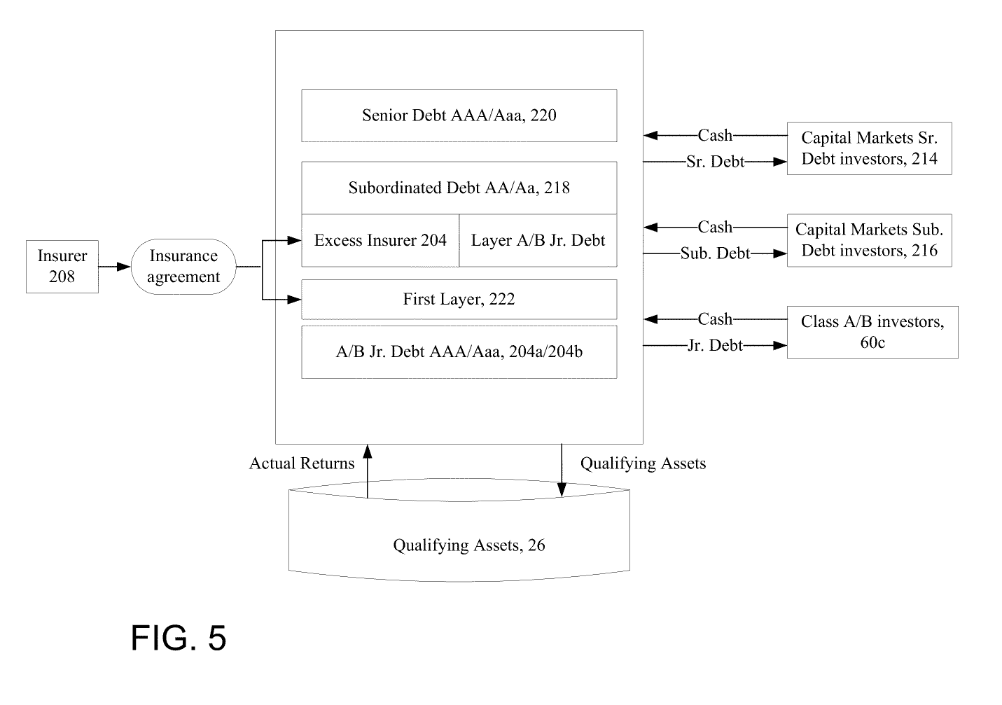

An accurate estimate of risk associated with collateral transactions enables the platform 10 to develop a capacity for a long-term source of such collateral. It also allows the platform 10 to provide and maintain a large, sustainable investment class for investors. As discussed further below (see, e.g., FIGS. 4 and 5), some of the assets to be placed in the reference account 48 are financed by third-party investors. These investments are categorized into tranches based on the risks. Although only one model is discussed, multiple models can be used in combination for the described processes.

The process 100 may vary based on the particular types of trading involved. For example, in some implementations, the process 100 only considers the underlying business, e.g., insurance/reinsurance business, conditions of the client 12a and/or cash flows, e.g., future interest payments, for which the platform 10 can obtain a security interest.

Referring to FIG. 4, in addition to the UPO 50 (unconditional payment obligation) and the eligible securities 52, the trust 26 can also be financed by third-party investors 60 and/or loans 62 from one or more banks 64a through, e.g., bank systems 64. The third-party investors 60 can provide cash 66 to the trust 26 in exchange for a finance note 68 issued by the platform 10. The investors 60 collect investment returns based on the note 68 from the total returns of the platform 10, e.g., fees collected from the client 12a.

The platform 10 issues the finance-note 68 based on its underlying business asset portfolio, related cash flows, and the features of the collateral notes to be issued. The finance-note 68 can be very highly rated (Standard & Poor's' rating) or equivalently-rated notes (e.g. Fitch or Moody's). Furthermore, the cash investment 70 in the trust 26 can be used to acquire one or more loan-notes 72 from the banks 64a that are secured by a portfolio of financial assets, e.g., bank loans and loan portfolio 62. From the loan-notes 72, the trust 26 is further financed by portfolio cash flows 76. In particular, the banks 64a and the platform 10 can enter into a Financing Facility Agreement (FFA) 90 and one or more underlying Financing Transaction Agreements (FTA) 92 with detailed terms for the banks' investment in the trust 26.

Thus, the transaction has a bank make a loan to its client, and that client posts securities issued by an unrelated company to secure the client's obligation to the bank. The bank is prohibited from transferring those securities. However, if the bank had a collateral note backed by those securities, the bank could raise cash against the collateral note. For example, under the FTA 92, the banks 64a may have FTA rights 94, such as in the trust 26, where in FIG. 4, KS(n) 78 is the contracting party with the bank as the special purpose vehicle (SPV) organized for the transaction. In some implementations, the platform 10 forms an additional trust (not shown here, see FIG. 6) to issue the finance-notes 68 to the investors 60 and to receive the portfolio cash flows 76 from the loan portfolio 62. In other implementations, the platform 10 handles the financing-related activities, and the cash 66 and/or the cash flows 76 are directly received by the trust 26.

Referring to FIG. 5, a capital structure 200 can be established for the platform 10 to raise assets/cash from the third-party investors 60 (FIG. 4) for the trust 26. For example, to raise $10 billion, three tranches of debt, senior debt 220, subordinated debt 218, and junior debt 202, are issued into the capital markets 214, 216 available to the investors 60a, 60b, 60c. Investors 60c of the junior debt 202 bear the highest risk and enjoy the highest interest rate. In particular, when the counterparty 14a (FIG. 1) draws assets from the trust 26 based on the collateral 18, assets raised from the junior debt 202 would be subject to the withdrawal before the other two tranches of debts. Furthermore, when the client 12a and the wrap providers 32a fund the trust for the withdrawal, and the assets raised from the junior debt 202 will be used to satisfy the demand, only when the wrap provider has defaulted on its obligation. Accordingly, the junior debt 202 bears higher risks of possible failure to reimburse the trust 26 than the other two tranches of debts. Among the entire assets raised from the investors 60, the junior debt 202 may constitute at least 3% (up to a maximum of $300 million when the total assets to be raised are $10 billion).

The junior debt 202 can further include two sub-tranches, class A junior debt 204A and class B junior debt 204B, each bearing different level of risks and having different interest rates. A detailed description of the two classes 204A, 204B is provided in U.S. Pat. No. 7,769,655, the entire content of which is incorporated herein by reference. Furthermore, due to the high risks the junior debt 202 bears, the platform 10 may also form insurance agreement(s) 206 with one or more independent insurers 208 to ensure the junior debt 202. The insurers 208 are highly rated. In some implementations, the insurers 208 are similar to or the same as the wrap providers 32a (FIG. 1) and provide similar services to the platform 10 to the wrap providers 32a. In the example shown in FIG. 5, the insurers 208 provide first layer 222 and an excess layer 224 of insurance, the details of which are discussed in U.S. Pat. No. 7,769,655. The insurers 208 can be paid with premiums (the premiums) earned from issuing the collateral 18 by the platform 10.

The subordinated debt 218 bears less risk than the junior debt 202 and more risks than the senior debt 220. In particular, assets raised from the subordinated debt 218 are drawn after the assets raised by the junior debt 202 and before the assets raised by the senior debt 220. Also, when the client 12a and/or the wrap providers 32a reimburse the withdrawn asset, the drawn assets raised from the subordinated debt 218 are reimbursed after the drawn assets raised from the senior debt 220 and before the drawn assets raised from the junior debt. Although not shown in FIG. 5, the assets raised from the subordinated debt 218 and the senior debt 220 can also be insured, e.g., using the wrap contracts 30 formed with the wrap providers 32a (FIG. 1). As an example, among the $10 billion assets raised through the capital structure 200, between 4% and 7% (up to a maximum of $700 million at closing) are from the subordinated debt 218, and up to 93% (up to a maximum of $9.3 billion) are from the senior debt 220. In some implementations, the subordinated debt 218 is rated A and can be issued with a coupon of six-month London Interbank Offered Rate (LIBOR) plus a spread of, for example, between 1.00% and 1.50%, have a final maturity of 20 years, and may be callable in years 10 and 15. The senior debt 220 is rated highly in accordance with the then current NRSRO guidelines and issued in a range of maturities appropriate to an asset and liability management criteria.

Assets, e.g., cash or other proceeds, raised from the debt issuance to the third-party investors 60 can be used to acquire loan portfolio 62 (FIG. 4) or acquire securities to be placed in the trust 26 and managed as an asset portfolio. The investment guidelines of the asset portfolio comply with desired investment limitations, e.g., the New York State Insurance Regulation 114, and include securities listed by the Securities Valuation Office of the NAIC. In general, these limitations require that all securities within the asset portfolio bear a minimum rating of A− or equivalent. Investment guidelines are subject to pre-approval by junior debt investors, and stipulate concentration limits by issuer, type and sector, and duration limits on a percentage composition and/or nominal value basis. An investment objective of the asset portfolio emphasizes yield over liquidity considerations, and is managed by one or more third party investment managers to optimize the trade-offs between yield, liquidity and complexity within its quality and qualification guidelines.

Referring to FIG. 6, a platform 300, having features similar or the same as those discussed for the platform 10 of FIGS. 1-5, provides multiple clients 302a, 302b, . . . , 302n with collateral 304a, 304b, . . . , 304n to enable the clients 302a, 302b, . . . , 302n to trade with respective counterparties 306a, 306b, . . . , 306n. (n represents any positive integer number of clients, counterparties, etc.) In FIG. 6, the platform 300 is represented as a phantom box that interacts with other features involved in FIG. 6 in a generally similar manner as discussed above for FIGS. 1-5 except that it would involve multiple entities.

In particular, the platform 300 interacts with a collateral trust 308 and a finance trust 310. The collateral trust 308 has features similar to those of the trust 26 (FIGS. 1-5) and holds assets that support the collateral 304a-304e. The assets in the collateral trust 308 include eligible securities 314a, 314b . . . 314n collected from respective clients 302a-302n and placed in respective series accounts 312a, 312b . . . 312n. Each series account 312a-312n holds only those eligible securities of a corresponding client and supports only those collaterals to be issued for the corresponding client in one or more collateral request. In addition, the assets in the collateral trust 308 also include investments collected by the finance trust 310. Examples of the investment collected from third-party investors 316 and other investment providers 318 are as discussed previously in FIGS. 4 and 5.

The collateral 304a-304n issued for clients 302a-302n, e.g., in the form of cashless collateral notes under CTAs as described previously, are deposited into respective accounts 320a, 320b . . . 320n to benefit the respective counterparties 306a-306n. The counterparties 306a-306n each becomes a holder of the deposited collateral note and can convert the collateral note at any time. The clients 302a-302n each has the obligation for reimbursing the collateral trust 308 for the amount converted by their respective counterparties. The investors 316, the other providers 318, and the collateral trust 308 bear the possible losses of assets, e.g., when the clients fail to reimburse the trust 308 in full.

To reduce the risk of losses, in addition to the series accounts 312a-312n, for each incidence of collateral issuance and deposition, the platform 300 forms a set of wrap contracts 324 with two or more wrap providers 322a, 322b . . . 322m (where m represents any integer number of wrap providers.) Under the wrap contracts 324, the wrap providers 322a-322m have joint and several liabilities to make the collateral trust 308 full after asset withdrawals, e.g., by paying the trust 308 the negative difference between the eligible securities held in the series accounts 312a-312n and the withdrawal amount of assets.

One or more parts of the platforms 10 and 300 are machine-based, e.g., established on processors. The processes involving the platforms 10 and 300, such as establishing the trusts 26, 308, 310, collecting eligible securities from the clients, creating series accounts for the clients, modeling risks, issuing and depositing collateral, and others can include computer programs stored and executed by a machine. The platform 300 can be accessible through a network, e.g., the Internet.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

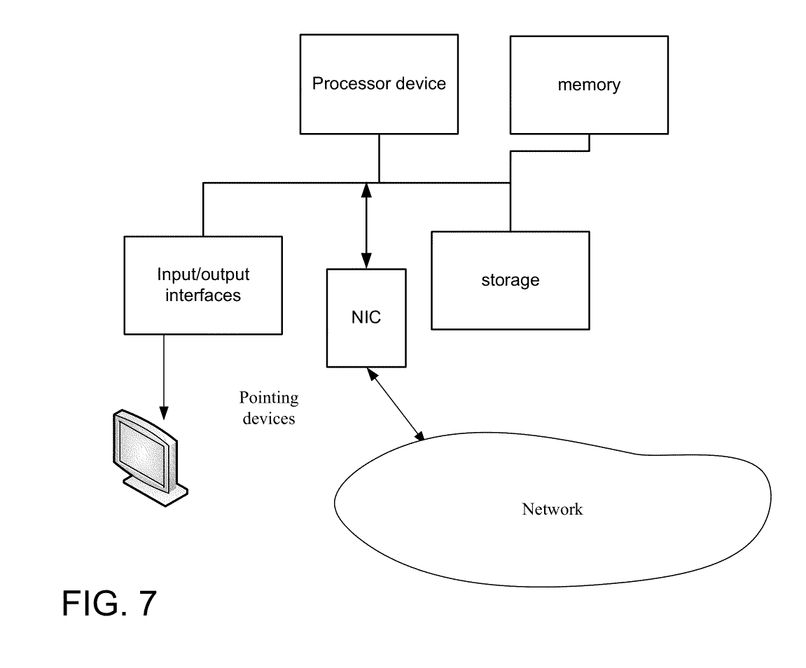

FIG. 7 is a schematic diagram of an example computer system 350. The system 350 can be used for practicing operations of the platform 10, 300 described above. For example, one or more parts of the platform 10, 300 can reside and be executed on the computer system 350. The system 350 can include a processor device 325, a memory 354, a storage device 356, and input/output interfaces 358 interconnected via a bus 360. The processor 352 is capable of processing instructions within the system 350. These instructions can implement one or more aspects of the systems, components and techniques described above. In some implementations, the processor 352 is a single-threaded processor. In other implementations, the processor 352 is a multi-threaded processor. The processor 352 can include multiple processing cores and is capable of processing instructions stored in the memory 354 or on the storage device 354 to display graphical information for a user interface on output monitor device 362.

The computer system 350 can be connected to a network 366, e.g., the Internet, through a network interface controller 368. Other systems, such as the client systems, the counterparty systems, the bank systems, etc. discussed above can also be connected to the same network or a different network that can communicate with the network.

The memory 354 is a computer readable medium such as volatile or non-volatile that stores information within the system 350. The memory 354 can store processes related to the functionality of the valuation system or valuation platform, for example. The storage device 356 is capable of providing persistent storage for the system 350. The storage device 356 can include a floppy disk device, a hard disk device, an optical disk device, or a tape device, or other suitable persistent storage mediums. The storage device 356 can store the various databases described above. The input/output device 358 provides input/output operations for the system 350. The input/output device 358 can include a keyboard, a pointing device, and a display unit for displaying graphical user interfaces.

An exemplary view of a computer system is shown in FIG. 7, and is but one example. In general, embodiments of the subject matter and the functional operations described in this specification can be implemented in digital electronic circuitry, or in computer software, firmware, or hardware. Embodiments of the subject matter described in this specification can be implemented as one or more computer program products, i.e., one or more modules of computer program instructions encoded on a computer readable medium for execution by, or to control the operation of, data processing apparatus. The computer readable medium is a machine-readable storage device. The invention can be embodied in and/or or used with various apparatus, devices, and machines for processing data, including by way of example a programmable processor, a computer, or multiple processors or computers.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment.

Embodiments of the invention can be implemented in a computing system that includes a back end component, e.g., as a data server, or that includes a middleware component, e.g., an application server, or that includes a front end component, e.g., a client computer having a graphical user interface or a web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A computer-implemented method comprising:
recording by one or more computers, receipt of a first request for obligations that grant to a first party a first participation right to allow a second party having commercial contracts with the first party to draw against assets of a legal trust, at least some of the assets in the legal trust being funded by investors;
determining terms for issuance of the obligations, the terms including a guarantee by the first party to redeem assets in the legal trust that are drawn by the second party;
recording, by the one or more computers, a first set of contracts formed with two or more independent contract providers unrelated to the first and second parties, the contract providers being jointly and severally liable for a negative difference between the value of assets the first party contributes to the legal trust and the value of the assets actually drawn by the second party; and
recording, by the one or more computers, a transfer of the requested obligations to a collateral account that benefits the second party.

2. The computer-implemented method of claim 1, wherein the first set of contracts comprises wrap contracts.

3. The computer-implemented method of claim 1, further comprising;
determining by the one or more computers risks associated with issuing the requested obligations.

4. The computer-implemented method of claim 3, wherein the terms for issuance of the obligations are determined based on the determined risks.

5. The computer-implemented method of claim 1, wherein the contract providers comprise financial institutions including banks or insurance companies or reinsurance companies.

6. The computer-implemented method of claim 1, wherein the first set of contracts is structured as unconditional payment guarantees or total return swaps or other guaranty contracts.

7. The computer-implemented method of claim 1, wherein the first set of contracts is used exclusively for the obligations transferred based on the first request.

8. The computer-implemented method of claim 7, further comprising
recording by the one or more computers receipt of other requests for obligations that grant to the first party participation rights to allow other parties having commercial contracts with the first party to draw against the assets of the legal trust; and
recording, by the one or more computers, additional sets of contracts formed with the two or more independent contract providers and/or other independent contract providers, different sets of contracts including the first set of contracts being independent of each other, and each set of contracts being used for a respective request for obligations.

9. The computer-implemented method of claim 1, further comprising
recording by the one or more computers receipt a second request for obligations that grant to a third party a second participation right to allow a fourth party having commercial contracts with the third party to draw against the assets of the legal trust;
determining terms for issuance of the obligations, the terms including a guarantee by the third party to redeem assets in the legal trust that are drawn by the fourth party;
recording, by the one or more computers, a second set of contracts formed with the two or more independent contract providers and/or other independent contract providers that are jointly and severally liable for a negative difference between the of the assets the third party contributes to the legal trust and the value of assets actually drawn by the fourth party.

10. The computer-implemented method of claim 1, wherein the assets in the legal trust also comprise eligible assets obtained from the first party for use in redeeming the assets drawn by the second party.

11. The computer-implemented method of claim 1, wherein the eligible assets are obtained before the transfer of the requested obligations.

12. A computer program product tangibly stored on a computer readable storage device, the computer program product comprising instructions for causing a processor to:
record receipt of a first request for obligations that grant to a first party a first participation right to allow a second party having commercial contracts with the first party to draw against assets of a legal trust, at least some of the assets in the legal trust being funded by investors;
receive terms for issuance of the obligations, the terms including a guarantee by the first party to redeem assets in the legal trust that are drawn by the second party;
record a first set of contracts formed with two or more independent contract providers unrelated to the first and second parties, the contract providers being jointly and severally liable for a negative difference between the value of the assets the first party contributes to the legal trust and the value of the assets actually drawn by the second party; and
record a transfer of the requested obligations to a collateral account that benefits the second party.

13. The computer program product of claim 12 wherein the first set of contracts comprises wrap contracts.

14. The computer program product of claim 12, further comprising instructions to:
determine risks associated with issuing the requested obligations.

15. The computer program product of claim 14 wherein the terms for issuance of the obligations are determined based on the determined risks.

16. The computer program product of claim 12 wherein the contract providers comprises financial institutions including banks or insurance companies or reinsurance companies.

17. The computer program product of claim 12 wherein the first set of contracts are structured as unconditional payment guarantees or total return swaps or other financial guaranty contracts.

18. The computer program product of claim 12 wherein the first set of contracts is used exclusively for the obligations transferred based on the first request.

19. The computer program product of claim 12, further comprising instructions to:
record receipt of other requests for obligations that grant to the first party participation rights to allow other parties having commercial contracts with the first party to draw against the assets of the legal trust; and
record additional sets of contracts formed with the two or more independent contract providers and/or other independent contract providers, different sets of contracts including the first set of contracts being independent of each other, and each set of contracts being used for a respective request for obligations.

20. The computer program product of claim 12, further comprising instructions to:
record receipt a second request for obligations that grant to a third party a second participation right to allow a fourth party having commercial contracts with the third party to draw against the assets of the legal trust;
determine terms for issuance of the obligations, the terms including a guarantee by the third party to redeem assets in the legal trust that are drawn by the fourth party;
record a second set of contracts formed with the two or more independent contract providers and/or other independent contract providers that are jointly and severally liable for a negative difference between of the value of the assets the third party contributes to the legal trust and the value of the assets actually drawn by the fourth party.

21. The computer program product of claim 12, wherein the assets in the legal trust also comprise eligible assets obtained from the first party for use in redeeming the assets drawn by the second party and the eligible assets are obtained before the transfer of the requested obligations.

22. A system comprises:
one or more computer system, each system comprising:
a processor; and
memory coupled to the processor; and the computer system configured to:
record receipt of a first request for obligations that grant to a first party a first participation right to allow a second party having commercial contracts with the first party to draw against assets of a legal trust, at least some of the assets in the legal trust being funded by investors;
receive terms for issuance of the obligations, the terms including a guarantee by the first party to redeem assets in the legal trust that are drawn by the second party;
record a first set of contracts formed with two or more independent contract providers unrelated to the first and second parties, the contract providers being jointly and severally liable for a negative difference between the value of assets the first party contributes to the legal trust and the value of the assets actually drawn by the second party; and
record a transfer of the requested obligations to a collateral account that benefits the second party.

23. The system of claim 22 wherein the first set of contracts comprises wrap contracts.

24. The system of claim 22, further configured to:
determine risks associated with issuing the requested obligations.

25. The system of claim 24 wherein the terms for issuance of the obligations are determined based on the determined risks.

26. The system of claim 22 wherein the first set of contracts are structured as unconditional payment guarantees or total return swaps or other financial guaranty contracts.

27. The system of claim 22 wherein the first set of contracts is used exclusively for the obligations transferred based on the first request.

28. The system of claim 22, further configured to:
record receipt of other requests for obligations that grant to the first party participation rights to allow other parties having commercial contracts with the first party to draw against the assets of the legal trust; and
record additional sets of contracts formed with the two or more independent contract providers and/or other independent contract providers, different sets of contracts including the first set of contracts being independent of each other, and each set of contracts being used for a respective request for obligations.

29. The system of claim 22, further configured to:
record receipt a second request for obligations that grant to a third party a second participation right to allow a fourth party having commercial contracts with the third party to draw against the assets of the legal trust;
determine terms for issuance of the obligations, the terms including a guarantee by the third party to redeem assets in the legal trust that are drawn by the fourth party;
record a second set of contracts formed with the two or more independent contract providers and/or other independent contract providers that are jointly and severally liable for a negative difference between the value of the assets the third party contributes the legal trust and the value of the assets actually drawn by the fourth party.

30. The system of claim 22 wherein the assets in the legal trust also comprise eligible assets obtained from the first party for use in redeeming the assets drawn by the second party and the eligible assets are obtained before the transfer of the requested obligations.
